(19) United States
(12) Patent Application Publication
(10) Pub. No.: US 2009/0274184 A1
(43) Pub. Date: Nov. 5, 2009

(54) OPTICAL UNIT

(75) Inventors: Kei Ikeda, Ehime (JP); Hiroyuki Ogawa, Osaka (JP)

Correspondence Address: Dickinson Wright PLLC;James E. Ledbetter, Esq., International Square, 1875 Eye Street, N.W., Suite 1200, Washington, DC, 20006, US

(73) Assignee: Matsushita Electric Industrial Co. Ltd., Osaka (JP)

(21) Appl. No.: 11/912,385

(22) PCT Filed: Apr. 25, 2006
(86) PCT No.: PCT/JP2006/308644

§ 371 Date: Jan. 26, 2009

(30) Foreign Application Priority Data
Apr. 25, 2005 (JP) 2005 126306

(51) Int. Cl. H01S 3/04

(52) U.S. Cl. 372/36

(57) ABSTRACT

The present invention provides an optical unit capable of suppressing a thermal influence on the optical element even if a heating source such as a laser driver is disposed near the optical element. A light pickup unit 9 of the present invention includes a beam splitter 12 and a collimate lens 13 at locations opposed to a laser driver 17. In a space 24 formed by the laser driver 17, the beam splitter 12 and the collimate lens 13, a thermal insulation sheet 18 is provided on the side of the laser driver 17, and a thermal conductive sheet 19 is provided on the side of the beam splitter 12 and the collimate lens 13.

### TECHNICAL FIELD

The present invention relates to an optical unit such as a light pickup unit which is integrally provided with an optical element such as a lens and a heating source such as a laser driver.

### BACKGROUND TECHNIQUE

As shown in FIG. 8, an optical unit having an optical element and a heating source which generates heat when power is turned ON, e.g., an optical system of a general light pickup unit includes a laser diode 1, a beam splitter 2, a collimate lens 3, a rising mirror 4, an objective lens 5 and a photodetector 6. A light beam emitted from the laser diode 1 is reflected by the beam splitter 2, and becomes parallel pencil of light by the collimate lens 3. This parallel pencil of light is reflected upward by the rising mirror 4, and forms a light spot on an optical disk D by the objective lens 5. The catoptric light from the optical disk D passes through the beam splitter 2 again through the objective lens 5, the rising mirror 4 and the collimate lens 3, and enters the photodetector 6. The photodetector 6 converts the incident light into an electric signal, outputs the same to a control circuit (not shown) and with this, the control circuit can read information on the optical disk D.

Operating current of laser emitted from the laser diode 1 is controlled by a laser driver 7. To enhance the response of current control by the laser driver 7, it is preferable that the laser driver 7 and the laser diode 1 are disposed as close as possible so that capacitance generated in an electricity path is reduced. Therefore, the laser driver 7 is generally incorporated in a light pickup unit, and is disposed near the laser diode 1 in many cases. Since various constituent elements of the optical system are also disposed near the laser diode 1, the optical elements such as the beam splitter 2 and the collimate lens 3 are disposed near the laser driver 7 in many cases.

In recent years, with diversification of optical recording media, speedup of recording speed is required for light pickup capable of recording (writing) in the media. To enhance the recording speed, it is necessary to control the laser diode 1 with higher output and higher speed, and since it is also required to downsize the light pickup unit, there is a tendency that the laser driver 7 is disposed closer to the laser diode 1. To record in higher density, the optical system of the light pickup unit needs to form a smaller record mark on a record medium (optical disk D), more severe specification is required for aberration ability. As the current control ability of the laser driver 7 is enhanced, there is a tendency that heat generated for driving the laser driver 7 is also increased.

Therefore, when there is no other choice but to dispose the laser driver 7 which is a main heating source in the light pickup unit near the optical element such as the beam splitter 2 and the collimate lens 3, the optical element is expanded or contracted due to the driving heat of the laser driver 7 or the index of refraction of a constituent material of the optical element is varied and aberration is generated, the record mark is expanded or distorted and the recording/reproducing ability is deteriorated in some cases. The recording/reproducing ability is affected when heat is locally transmitted to the optical element and the optical element is not thermally changed uniformly and deviation is generated and astigmatic aberration is generated in the optical system. When a degree of the astigmatic aberration is large, the recording operation is interrupted by deterioration in a reproduction signal or a servo signal, a record mark is expanded and it becomes impossible to carry out the recording operation, a load on the laser driver is increased due to shortage of recording power, and serious effect is brought about. On the other hand, in the conventional technique shown in FIG. 8, a thermal insulation sheet 8 is sandwitched between the laser driver 7 and the optical element as thermal measure, but with downsizing and higher performance tendencies, it is necessary to take further measures (see patent document 1 as a technique in which attention is paid to heat radiation of an optical integrated element alone).
[Patent Document 1] Japanese Patent Application Laid-open No. 2000-163756

The present invention has been accomplished in view of the above circumstances, and it is an object of the invention to provide an optical unit capable of suppressing a thermal influence on the optical element even if a heating source such as a laser driver is disposed near the optical element.

### DISCLOSURE OF THE INVENTION

According to a first aspect of the present invention, there is provided an optical unit having an optical element at a location opposed to a heating source, wherein in an opposing space formed by said heating source and said optical element, a thermal insulator is provided on the side of said heating source or said optical element, and a thermal conductive material is provided on the side of said optical element or said heating source.

According to a second aspect of the invention, there is provided an optical unit wherein an optical element is provided in a recess formed in a base which receives heat from a heating source, and a thermal conductive material lies astride between at least one end of an opening edge of said recess and the other end which is opposed to the one end.

According to a third aspect of the invention, there is provided an optical unit wherein a heating source provided adjacent to an optical element is fixed to a board located on the opposite side from said optical element, an opening for radiating heat generated by said heating source is formed in said board, and a thermal conductive material for transmitting heat to the opposite side from said heating source with respect to said board is disposed in said opening.

According to the present invention, even if a heating source such as a laser driver is disposed near an optical element in the unit, heat and heat radiation transmitted to the optical element can be disposed by a thermal conductive material which is appropriately disposed. Therefore, it is possible to suppress thermal influence on the optical element, and it is possible to realize a small optical unit having high performance in which aberration is less prone to be generated in the optical system.

### BRIEF DESCRIPTION OF THE DRAWINGS

FIG. 1 is an explanatory diagram showing an optical system of an optical pickup unit according to an embodiment 1 of the present invention;

FIG. 2 is a side sectional view showing the optical pickup unit of the embodiment 1 of the invention;

FIG. 3 is a front sectional view at a position taken along the line III-III in FIG. 2;

FIG. 4 is a front sectional view showing an optical pickup unit according to an embodiment 2 of the invention;

FIG. 5 is a front sectional view showing an optical pickup unit according to an embodiment 3 of the invention;

FIG. 6 is a front sectional view showing an optical pickup unit according to an embodiment 4 of the invention;

FIG. 7 is a side sectional view showing another example of the optical pickup unit according to the embodiment 4 of the invention; and

FIG. 8 is an explanatory diagram showing an optical system of a conventional optical pickup unit.

### BEST MODE FOR CARRYING OUT THE INVENTION

The optical unit of the first aspect of the invention includes an optical element at a location opposed to a heating source, and in an opposing space formed by the heating source and the optical element, a thermal insulator is provided on the side of the heating source or the optical element, and a thermal conductive material is provided on the side of the optical element or the heating source.

According to this aspect, a portion of heat from the heating source which is not insulated by the thermal insulator is dispersed by the thermal conductive material and transmitted to the optical element, or a portion of heat from the heating source is dispersed by the thermal conductive material and then insulated by the thermal insulator and transmitted to the optical element. Therefore, heat transmitted to the optical element does not concentrate on a portion of the optical element and is uniformly equalized over the entire optical element, the optical element is not thermal varied, or even if the optical element is thermally varied, the thermal variation is lightly generated over the entire optical element, and thermal influence on the optical element can be suppressed.

In the optical unit of the second aspect of the invention, an optical element is provided in a recess formed in a base which receives heat from a heating source, and a thermal conductive material lies astride between at least one end of an opening edge of the recess and the other end which is opposed to the one end.

According to this aspect, even if heat from the heating source is transmitted to the optical element through the base, the heat is transmitted to the thermal conductive material provided near the optical element and dispersed. Therefore, heat transmitted to the optical element does not concentrate on a portion of the optical element and is uniformly equalized over the entire optical element, the optical element is not thermal varied, or even if the optical element is thermally varied, the thermal variation is lightly generated over the entire optical element, and thermal influence on the optical element can be suppressed. Especially when one end of the opening edge is closer to the heating source than the other end, heat is not intensively transmitted to the optical element from the one end, and dispersed heat is transmitted to the other end from the one end and thus, deformation and deterioration of only a portion of the optical element can effectively be prevented.

In the optical unit of the third aspect of the invention, a heating source provided adjacent to an optical element is fixed to a board located on the opposite side from the optical element, an opening for radiating heat generated by the heating source is formed in the board, and a thermal conductive material for transmitting heat to the opposite side from the heating source with respect to the board is disposed in the opening.

With this aspect, heat from the heating source is transmitted to the thermal conductive material disposed in the opening of the board. Therefore, heat from the heating source is positively dispersed also on the opposite side from the optical element, heat transmitted to the optical element is reduced, and thermal influence on the optical element can be suppressed.

### Embodiment 1

Concrete embodiments of the present invention will be explained based on the drawings.

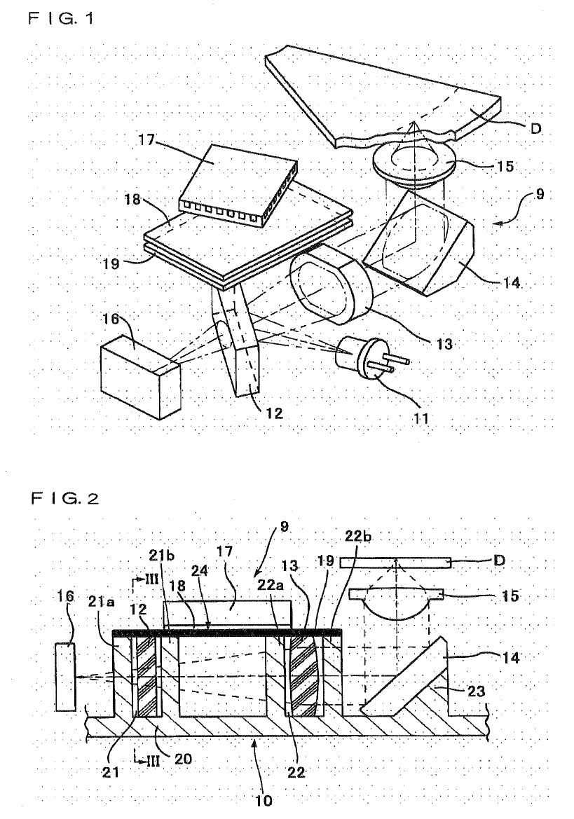

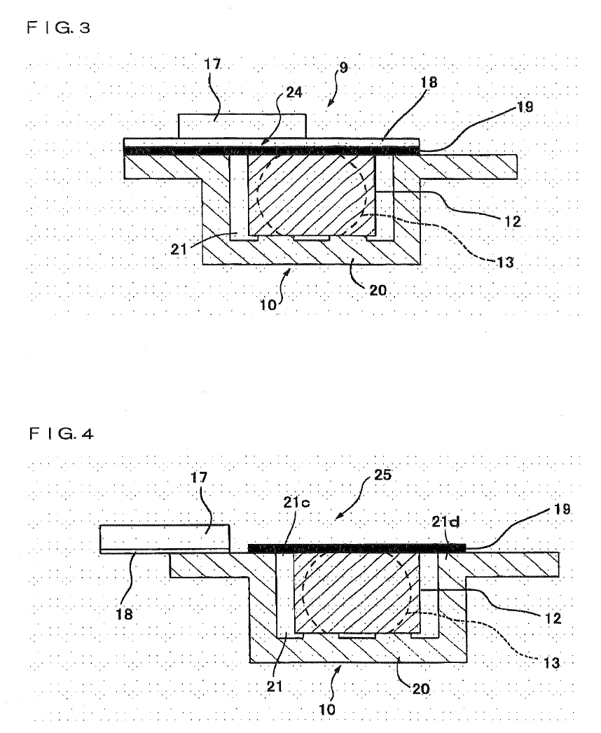

FIGS. 1 to 3 show a light pickup unit according to an embodiment 1. The light pickup unit 9 includes a base 10, a laser diode 11, a beam splitter 12, a collimate lens 13, a rising mirror 14, an objective lens 15, a photodetector 16, a laser driver 17, a thermal insulation sheet 18 and a thermal conductive sheet 19.

The base 10 is made of metal. The base 10 includes a flat plate-like base portion 20, grooves 21 and 22 which are formed in an upper surface of the base portion 20 and open upward (surrounded from four directions), and a mirror mounting portion 23 disposed on the same straight line with the grooves 21 and 22 on the upper surface of the base portion 20. The beam splitter 12 is fitted into the groove 21, the collimate lens 13 is fitted into the groove 22, and the rising mirror 14 is mounted on the mirror mounting portion 23. A light beam emitted from the laser diode 11 is reflected by the beam splitter 12, and becomes a parallel pencil of light by the collimate lens 13. The parallel pencil of light is reflected upward by the rising mirror 14, and forms a light spot on the optical disk D by the objective lens 15. A catoptric light from the optical disk D again passes through the beam splitter 12 through the objective lens 15, the rising mirror 14 and the collimate lens 13, and enters the photodetector 16. The photodetector 16 converts the incident light into an electric signal, outputs the same to a control circuit (not shown), and thus, the control circuit can read information on the optical disk D.

The laser driver 17 is flat rectangular shape as viewed from above, and controls operating current of laser emitted from the laser diode 11. The laser driver 17 is provided above the grooves 21 and 22 such as to be opposed to the grooves 21 and 22 (beam splitter 12 and collimate lens 13). The thermal insulation sheet 18 and the thermal conductive sheet 19 are laminated on each other and inserted into a fine space 24 defined by the laser driver 17 and opening edges of the grooves 21 and 22. The thermal insulation sheet 18 and the thermal conductive sheet 19 have the same rectangular shape as viewed from above (rectangular shape having such a size that these sheets cover the laser driver 17 as viewed from above). The thermal insulation sheet 18 is located in the space 24 on the side of the laser driver 17, and the thermal conductive sheet 19 is located in the space 24 on the side of the grooves 21 and 22 (beam splitter 12 and collimate lens 13). An air thermal insulator having air bubbles therein or a vacuum thermal insulator is used as the thermal insulation sheet 18 for example. A metal leaf or a graphite sheet is used as the thermal conductive sheet 19 for example.

According to the light pickup unit of this embodiment, the laser driver 17 having a flat package equally generates heat to its periphery when the laser driver 17 is operated, and a portion of the heat which is not insulated by the thermal insulation sheet 18 is transmitted to the thermal conductive sheet 19. Then, the heat from the laser driver 17 is dispersed by the thermal conductive sheet 19 in a form of a sheet, and transmitted to the beam splitter 12 or the collimate lens 13 disposed in the grooves 21 and 22. Therefore, the heat transmitted to these optical elements does not concentrate on portions of the optical elements, but is equally dispersed to the entire optical elements.

Especially, one end 21b of the opening edge of the groove 21 is located closer to the laser driver 17 than the other end 21a, but the thermal conductive sheet 19 lies astride between the one end 21b and the other end 21a (see FIG. 2), heat is not intensively transmitted to the beam splitter 12 from the one end 21b, but the dispersed heat is transmitted from the one end 21b to the other end 21a. Similarly, one end 22b of the opening edge of the groove 22 is located closer to the laser driver 17 than the other end 22a, but the thermal conductive sheet 19 lies astride between the one end 22b and the other one end 22a, heat is not intensively transmitted to the collimate lens 13 from the one end 22a, but the dispersed heat is transmitted from the one end 22a to the other end 22b.

Therefore, an amount of far infrared rays radiated from the thermal conductive sheet 19 to the optical elements (beam splitter 12 and collimate lens 13) is equalized, and the thermal distribution (polarized heat) in front and back directions (optical axial direction) of each optical element is equalized and thus, it is possible to suppress the thermal influence on each optical element and to reduce the heat aberration.

In this embodiment, the laser driver 17 and the grooves 21 and 22 (beam splitter 12 and collimate lens 13) are opposed to each other. The term “opposed to each other” includes not only a case in which front surfaces of the laser driver and the grooves are opposed to each other (a lower surface of the former and an upper surface of the latter are opposed to each other), but also a case in which an extension of a front surface of one of them is opposed to a front surface of the other even if they are slightly deviated within such a range that heat is transmitted therebetween.

### Embodiment 2

FIG. 4 shows a light pickup unit according to an embodiment 2. The light pickup unit 25 is different from the light pickup unit 9 in that the laser driver and the thermal insulation sheet are located at positions deviated in the lateral direction with respect to the grooves (optical elements), but these light pickup units are the same in the other structure and thus, the same members are designated with the same symbols as those of the embodiment 1 in this embodiment also, and explanation there of will be omitted.

According to the light pickup unit 25, the laser driver 17 and the thermal insulation sheet 18 are not located directly above the grooves 21 and 22 (beam splitter 12 and collimate lens 13) but are located at positions deviated leftward in FIG. 4. The thermal insulation sheet 18 has substantially the same size as that of the laser driver 17 in the lateral direction, and the laser driver 17 is in contact with an upper portion of the base 10 through the thermal insulation sheet 18. When the laser driver 17 is driven, the base 10 receives a portion of heat from the laser driver 17 which was not insulated by the thermal insulation sheet 18.

In this embodiment, a left end 21c of an opening edge of the groove 21 is located closer to the laser driver 17 than the right end 21d, but the thermal conductive sheet 19 lies astride between the left end 21c and the right end 21d, heat is not intensively transmitted to the beam splitter 12 from the left end 21c, but the dispersed heat is transmitted from the left end 21c to the right end 21d. Similarly, a left end of an opening edge of the groove 22 is located closer to the laser driver 17 than the right end, but the thermal conductive sheet 19 lies astride between the left end and the right end, heat is not intensively transmitted to the collimate lens 13 from the left end, but the dispersed heat is transmitted from the left end to the right end.

An amount of far infrared rays radiated from the thermal conductive sheet 19 to the optical elements is equalized, and the thermal distribution of each optical element in the lateral direction is equalized. Therefore, it is possible to suppress the thermal influence on each optical element and to reduce the heat aberration.

The thermal conductive sheet 19 extends laterally and lies astride between the left end and the right end of the opening edge of each groove. This structure is the same as that of the embodiment 1. However, in the embodiment 2, since the laser driver 17 is largely deviated toward the left end with respect to the right end, the thermal conductive sheet 19 eliminates polarized heat more effectively.

### Embodiment 3

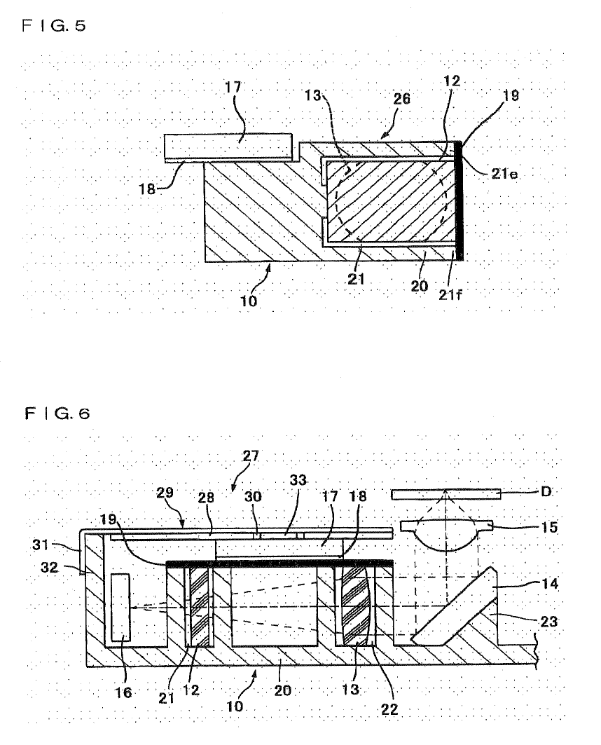

FIG. 5 shows a light pickup unit according to an embodiment 3. The light pickup unit 26 is different from the light pickup unit 25 in that the grooves 21 and 22 are opened sideway, but the other structure is the same as that of the embodiment 2 and thus, explanation thereof will be omitted.

According to the light pickup unit 26, the grooves 21 and 22 are opened rightward in FIG. 5, and the thermal conductive sheet 19 lies astride between an upper end and a lower end of an opening edge of each groove. The thermal conductive sheet 19 also lies between the left end and the right end of the opening edge of each groove (as for the groove 21, an opening edge end (left end) on a front side of a paper sheet of FIG. 5 and an opening edge (right end) on a back side of the paper sheet of FIG. 5), but the structure is not limited to this.

In this embodiment, an upper end 21e of the opening edge of the groove 21 is located closer to the laser driver 17 than a lower end 21f, but the thermal conductive sheet 19 lies astride between the upper end 21e and the lower end 21f, heat is not intensively transmitted to the beam splitter 12 from the upper end 21e, but the dispersed heat is transmitted from the upper end 21e to the lower end 21f. Similarly, an upper end of the opening edge of the groove 22 is located closer to the laser driver 17 than a lower end, but the thermal conductive sheet 19 also lies astride between the upper end and the lower end, heat is not intensively transmitted to the collimate lens 13 from the upper end, but the dispersed heat is transmitted from the upper end to the lower end.

An amount of far infrared rays radiated from the thermal conductive sheet 19 to the optical elements is equalized, and the thermal distribution of each optical element in the vertical is equalized. Therefore, it is possible to suppress the thermal influence on each optical element and to reduce the heat aberration.

### Embodiment 4

FIG. 6 shows a light pickup unit according to an embodiment 4. The light pickup unit 27 is different from the light pickup unit 9 in that the laser driver 17 is mounted on a wiring board 28, the wiring board 28 is mounted on the base 10 through a metal cover 29, and the thermal insulation sheet 18 has the same size not as that of the thermal conductive sheet 19 but as that of the laser driver 17. Other structure is the same as that of the embodiment 1 and thus, the same members are designated with the same symbols and explanation thereof will be omitted.

The wiring board 28 is located on the opposite side (upper side) from the grooves 21 and 22 (beam splitter 12 and collimate lens 13) with respect to the laser driver 17. An opening 30 is formed in the wiring board 28 at a location where the laser driver 17 is mounted. An upper surface of the wiring board 28 is fixed to the cover 29, and a left end 31 of the cover 29 is mounted on a cover mounting portion 32 formed on the base 10. With this, each element is sandwiched between the cover 29 and the base 10 from above and below and is held therebetween. A thermal conductive member 33 comprising a heat-radiation grease is disposed in the opening 30 of the wiring board 28 such that the thermal conductive member 33 is in contact with the laser driver 17 and the cover 29.

In this embodiment, heat from the laser driver 17 is transmitted to the thermal conductive member 33 disposed in the opening 30 of the wiring board 28 and transmitted to the cover 29. With this, heat of the laser driver 17 is positively dispersed also in the opposite side from the grooves 21 and 22 (beam splitter 12 and collimate lens 13), and the amount of heat transmitted to the optical element is reduced, and the thermal influence on the optical element can be suppressed. Especially, the size and disposition of the thermal conductive member 33 with respect to the opening 30 are changed, and a heat radiating performance of the laser driver 17 toward its back side (upper side) can be adjusted.

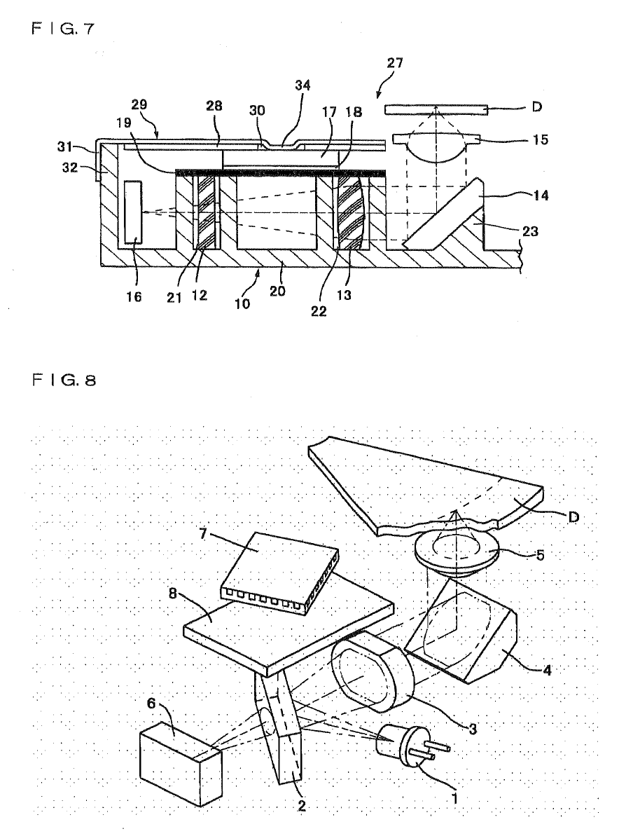

Alternatively, the thermal conductive material need not be independent from the cover 29, and if a portion of the cover 29 is formed into a tongue shape and the portion of the cover 29 is abutted against the laser driver 17 as shown in FIG. 7, the same effect can be obtained (in FIG. 7, a reference number 34 represents an abutment portion of the cover 29).

Although the embodiments of the present invention have been explained above, the invention is not limited to the embodiments. For example, materials other than metal, graphite and radiation grease may be used for the thermal conductive sheet 19 and the thermal conductive member 33 if the thermal conductivity is high.

When the thermal insulation sheet 18 and the thermal conductive sheet 19 are inserted into the space 24 in a state where these sheets are laminated on each other, the thermal insulation sheet 18 is disposed on the side of the laser driver 17 and the thermal conductive sheet 19 is disposed on the side of the optical element in the embodiments, but they may be disposed reversely. At that time, heat from the laser driver 17 is dispersed by the thermal conductive sheet 19 and insulated by the thermal insulation sheet 18 and transmitted to the optical element. Therefore, heat transmitted to the optical element does not concentrate on a portion of the optical element, and is uniformly equalized over the entire optical element.

As shown in FIGS. 6 and 7, the size of the thermal conductive sheet 19 may not be the same as that of the thermal insulation sheet 18, and the thermal conductive sheet 19 may be greater in size than the thermal insulation sheet 18. The groove need not open upward or rightward.

The present invention can be utilized not only for the light pickup unit but also for other optical unit integrally provided with an optical element and a heating source.

1. An optical unit having an optical element at a location opposed to a heating source, wherein in an opposing space formed by said heating source and said optical element, a thermal insulator is provided on the side of said heating source or said optical element, and a thermal conductive material is provided on the side of said optical element or said heating source.

2. An optical unit wherein an optical element is provided in a recess formed in a base which receives heat from a heating source, and a thermal conductive material lies astride between at least one end of an opening edge of said recess and the other end which is opposed to the one end.

3. An optical unit wherein a heating source provided adjacent to an optical element is fixed to a board located on the opposite side from said optical element, an opening for radiating heat generated by said heating source is formed in said board, and a thermal conductive material for transmitting heat to the opposite side from said heating source with respect to said board is disposed in said opening.
